(19) United States
(12) Patent Application Publication
(10) Pub. No.: US 2003/0202340 A1
(43) Pub. Date: Oct. 30, 2003

(54) Ornamental lamp

(76) Inventor: Ching-Yen Wu, Sanchung City (TW)

Correspondence Address: Rabin & Berdo, P.C., Suite 500, 1101 14th Street, Washington, DC, 20005, US

(21) Appl. No.: 10/128,360

(22) Filed: Apr. 24, 2002

(51) Int. Cl. F21S 8/08

(52) U.S. Cl. 362/101; 362/251; 362/410; 362/227

(57) ABSTRACT

An ornamental lamp has a base. A secondary light bulb is mounted on top of the base. A barrel is also mounted on top of the base and around the secondary light bulb. A bottle containing water and wax is mounted on the barrel and having a bottom end inserted into the barrel to be close to the secondary light bulb. Two rods securely stand on the base and a plate is securely mounted on top ends of the rods. Two sockets are mounted on the plate and two primary light bulbs are respectively plugged to the sockets. A shade is maintained in a position above the primary light bulbs by a pole securely connected between the plate and the shade. Therefore, by such arrangement, the ornamental lamp can be used for illumination as well as providing an ornamental effect.

### BACKGROUND OF THE INVENTION

1. Field of the Invention

The present invention relates to the field of lamps, and more particularly to a lamp that can be used for illumination as well as providing an ornamental effect.

2. Description of Related Art

There are numerous kinds of lamps available in the market, for example, table or desk lamps, floor lamps, wall lamps, bedside lamps and so forth. Most of the lamps are used primarily for illumination while some are designed to provide ornamental effects as a secondary function. However, the ornamental effects provided by the lamps are usually stationary and invariable so after a period of time, the ornamental effects will be dull and unattractive to observers.

There is another kind of conventional ornamental lamp shown in FIG. 4 that includes a hollow base (90), a light bulb (92) mounted in the base (90) and a transparent bottle (94) mounted on top of the base (90). The transparent bottle (94) is filled with a mixture of water (942) and wax (944). In operation of the lamp, the light bulb (92) illuminates and generates heat that causes a temperature variation throughout the bottle (94). Moreover, the temperature variation results in a density variation in the mixture so that the water (942) and wax (944) starts to circulate randomly in the bottle (94). Therefore, the ornamental lamp provides a unique and versatile ornamental effect that has recently made the lamp become popular. However, the ornamental lamp can only provide dim illumination, because the light bulb (92) has a low capacity and is received in the base (90) so that limited light indirectly scatters through the bottle (94).

Therefore, the present invention intends to provide an ornamental lamp that can be used for illumination as well as providing a unique and versatile ornamental effect.

### SUMMARY OF THE INVENTION

The objective of the present invention is to provide an ornamental lamp that can be used for illumination as well as providing an ornamental effect.

Other objectives, advantages and novel features of the invention will become more apparent from the following detailed description when taken in conjunction with the accompanying drawings.

To achieve the mentioned objectives, the ornamental lamp has a base having at least one secondary light bulb mounted on a top surface of the base. A barrel is mounted on the top surface of the base and around the secondary light bulb. A bottle is mounted on the barrel and has a bottom end inserted into the barrel to be close to the secondary light bulb. The bottle contains water and wax. At least one rod securely stands on the top surface the base. A plate is securely mounted on a top end of the rod. At least one socket is mounted on a top surface of the plate. At least one primary light bulb is plugged into the socket. Wires are electrically connected to the primary light bulb and secondary light bulb.

### BRIEF DESCRIPTION OF THE DRAWINGS

FIG. 1 is an exploded perspective view of an ornamental lamp in accordance with the present invention;

FIG. 2 is a cross-sectional view of the ornamental lamp;

FIG. 3 is a perspective view of the ornamental lamp in assembly; and

FIG. 4 is a perspective view showing a kind of conventional ornamental lamp.

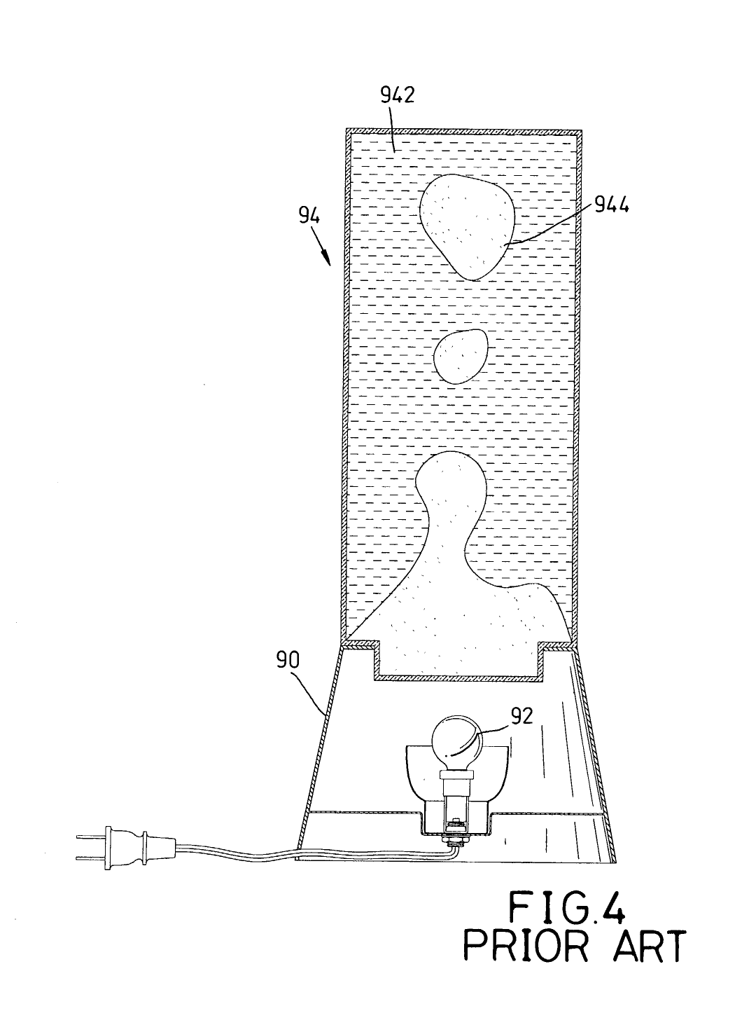

### DETAILED DESCRIPTION OF THE PREFERRED EMBODIMENT

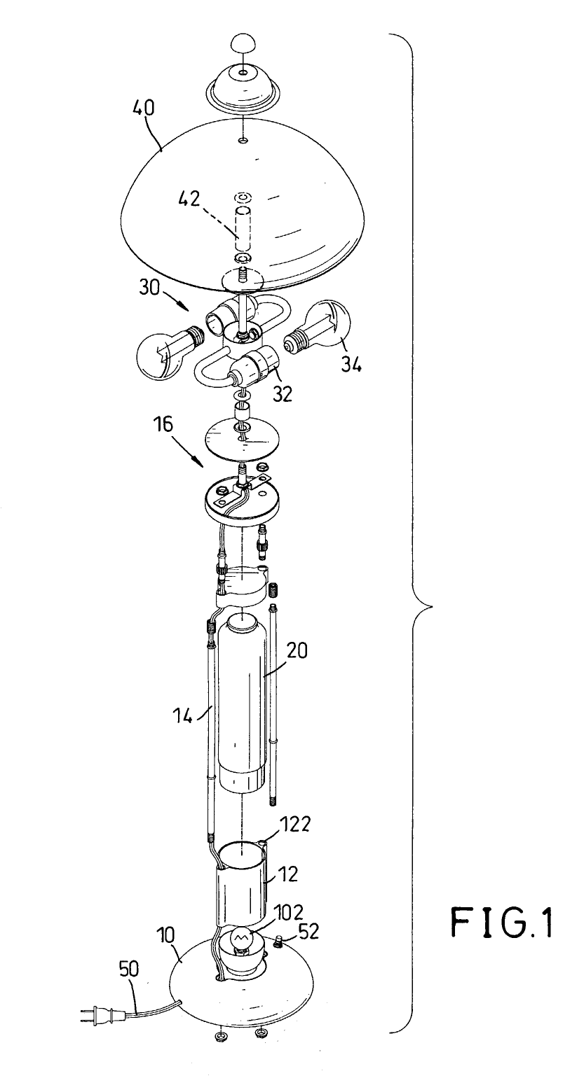

With reference to FIG. 1, an ornamental lamp in accordance with the present invention has a base (10). A secondary light bulb (102) is mounted on top of the base (10). A barrel (12) is also mounted on top of the base (10) and around the light bulb (102). Two hollow rods (14) respectively extend through bores (122) defined in the barrel (12) and further extend into holes (102) defined in the base (10) so as to securely stand the rods (14) on the base (10). A plate (16) is securely mounted onto top ends of the rods (14).

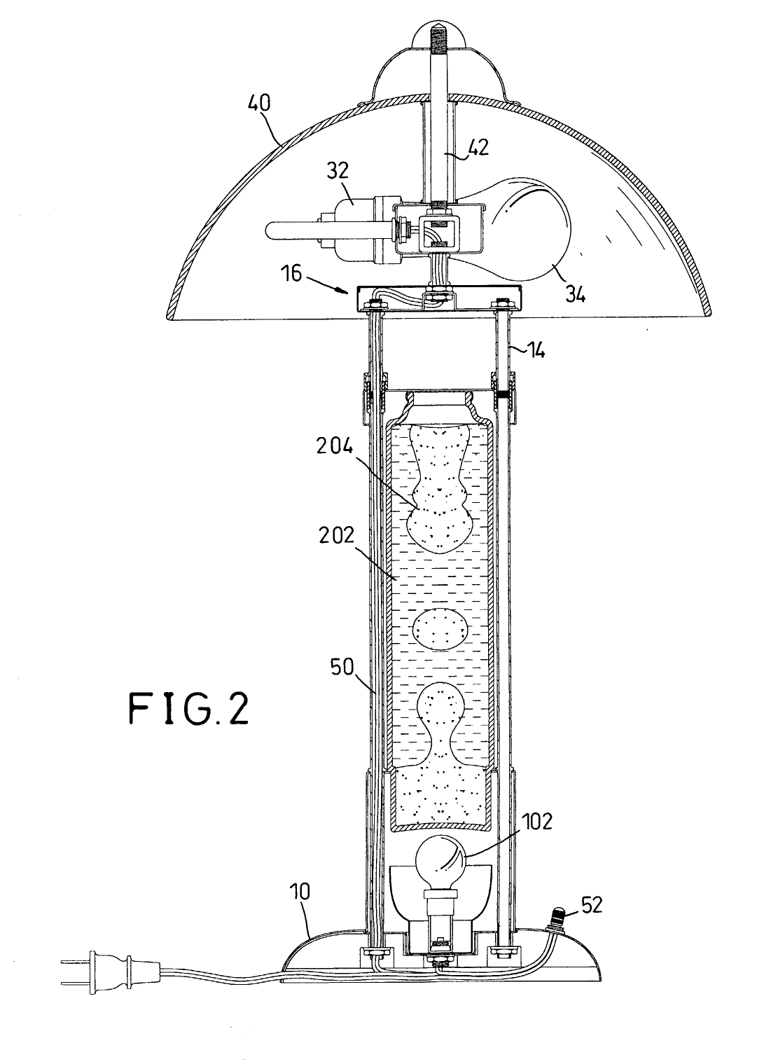

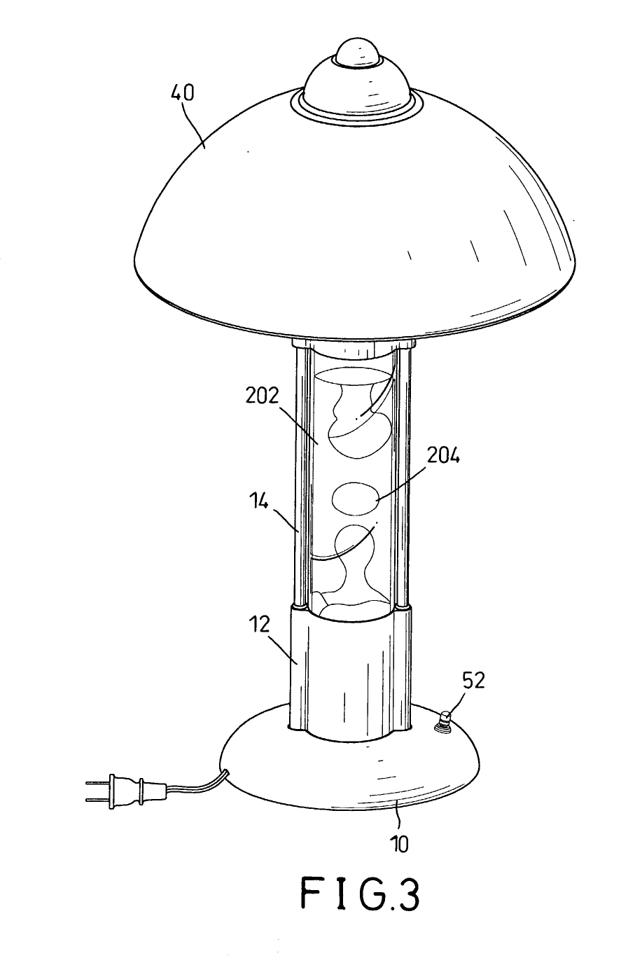

A bottle (20) is mounted on the barrel (12) and located between the rods (14), and has a bottom end inserted into the barrel (12) to be close to the secondary light bulb (102). The bottle (20) contains a mixture of water (202) and wax (204) as shown in FIGS. 2 and 3.

An illumination assembly (30) is mounted on a top surface of the plate (16), and includes two sockets (32) and two primary light bulbs (34) respectively plugged to the sockets (32).

A shade (40) is maintained in a position above the illumination assembly (30) via a pole (42) securely connected between the plate (16) and the shade (40).

With reference to FIGS. 1 and 2, two wires (50) are disposed via the base (10) and rods (14) to electrically connect the secondary light bulb (102) and the primary light bulbs (32). A button (52) is mounted on the base (10) and also electrically connected to the wires (50) so as to control the secondary light bulb (102) and the light bulbs (32).

With reference to FIGS. 2 and 3, in operation of the ornamental light, the secondary light bulb (102) and the primary light bulbs (32) are lighted. Because of the bottom end of the bottle (20) being close to the secondary light bulb (102), the bottom end is first heated and later, a temperature variation is formed throughout the bottle (20). Therefore, the water (202) and wax (204) start to circulate randomly and together with the light scattering through the bottle (20), a unique and versatile ornamental effect is thereby created.

Moreover, not considering the bottle (20) and the secondary light bulb (102), the rest of the ornamental lamp is similar to a conventional table lamp and is capable of providing satisfying illumination as well. Therefore, the main characteristic of the present invention is to combine the illumination assembly (30) with the bottle and the light bulb (102) so as to form an ornamental lamp that can be used for illumination and ornamental purpose.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An ornamental lamp comprising:
a base having at least one first light bulb mounted on a top surface of the base;
a barrel mounted on the top surface of the base and around the at least one secondary light bulb;
a bottle mounted on the barrel and having a bottom end inserted into the barrel to be close to the at least one secondary light bulb, the bottle having water and wax contained therein;
at least one rod securely standing on the top surface the base;
a plate securely mounted on a top end of the at least one rod;
at least one socket mounted on a top surface of the plate;
at least one second light bulb plugged to the at least one socket; and
wires electrically connected to the at least one primary light bulb and secondary light bulb.

2. The ornamental lamp as claimed in claim 1, further comprising a shade mounted above the at least one primary light bulb and a pole securely connected between the shade and the plate.

3. The ornamental lamp as claimed in claim 1, further comprising a button electrically connected to the wires for controlling the at least one primary light bulb and secondary light bulb.

4. The ornamental lamp as claimed in claim 3, wherein the button is mounted on the top surface of the base.

5. The ornamental lamp as claimed in claim 1, wherein the first light bulb is a secondary light bulb and the secondary light bulb is a primary light bulb.
